(19) United States
(12) Patent Application Publication
(10) Pub. No.: US 2024/0144137 A1
(43) Pub. Date: May 2, 2024

(54) PROCUREMENT MODELING SYSTEM FOR PREDICTING PREFERENTIAL SUPPLIERS AND SUPPLIER PRICING POWER

(71) Applicant: Arkestro Inc., San Francisco, CA (US)

(72) Inventors: Edmund Adam ZAGORIN, San Francisco, CA (US); Benjamin Kingsland LEIKEN, Venice, CA (US); Eric David BURAS, Denver, CO (US)

(21) Appl. No.: 17/976,659

(22) Filed: Oct. 28, 2022

(51) Int. Cl. G06Q 10/06; G06Q 10/08

(52) U.S. Cl. CPC G06Q 10/06375; G06Q 10/08

(57) ABSTRACT

A method implemented by computer servers associated with a procurement services platform includes accessing data for a set of transactions associated with a potential procurement transaction between a purchaser entity and a plurality of supplier entities. The transactions include line-items. The method includes inputting the data for the set of transactions into a machine-learning model trained to generate a preferential ranking for each of the plurality of supplier entities based on the line-items. The preferential ranking includes an estimated preference of the purchaser entity for a supplier entity of the plurality of supplier entities to supply a product or service to the purchaser entity. The method further includes generating, by the machine-learning model, the preferential ranking for each of the plurality of supplier entities, and providing, based on the preferential rankings, a recommendation of preferential supplier entities for supplying the product or service to the purchaser entity.

### TECHNICAL FIELD

This application relates generally to a procurement modeling system, and, more particularly, to a procurement modeling system for predicting preferential supplier entities and supplier pricing power for a purchasing entity.

### BACKGROUND

Procurement services may generally include software for aiding purchaser entities to purchase and procure requisite products or services from one or more supplier entities for purposes of doing business. In many potential procurement transactions, a purchaser entity's constraints may be to ensure that the price to be paid for the requisite products and services is reasonable and that the potential supplier entities can be relied upon to deliver the requisite products and services at the reasonable price. In some instances, a purchaser entity may make certain tradeoffs between price and reliability if, for example, one or more potential supplier entities at a lower price are restricted by geographical location or lack adequate technical support after the requisite products and services are procured, for example. It may be useful to provide techniques to identify suitable supplier entities for a particular purchaser entity.

### SUMMARY

Embodiments of the present disclosure are directed toward a procurement modeling system including one or more computer servers for predicting preferential supplier entities and supplier pricing power for a purchaser entity. In certain embodiments, the one or more computer servers may access data for a set of transactions associated with a potential procurement transaction between a purchaser entity and at least one of a plurality of supplier entities. In one embodiment, at least one of the transactions includes a line-item. In certain embodiments, the set of transactions may include a line-item and an identification of the purchaser entity. In one embodiment, the line-item may include one or more of a price of the product or service, a quantity of the product or service, or a unit of measure (UOM) with respect to the product or service. In certain embodiments, the one or more computer servers may then input the data for the set of transactions into a machine-learning model trained to generate a preferential ranking for each of the plurality of supplier entities based on the line-item. In one embodiment, the preferential ranking may include an estimated preference of the purchaser entity for a supplier entity of the plurality of supplier entities to supply a product or service to the purchaser entity, in which the product or service corresponds to the line-item.

In certain embodiments, the one or more computer servers may then generate, by the machine-learning model, the preferential ranking for each of the plurality of supplier entities. In some embodiments, the preferential ranking may be determined based on a market competitiveness score with respect to products or services offered by the plurality of supplier entities. In some embodiments, the preferential ranking may be determined based on a monetary value of a sum of procurement transactions between the purchaser entity and each of the plurality of supplier entities with respect to the product or service. In some embodiments, the preferential ranking may be determined based on a determined negotiation behavior of each of the plurality of supplier entities. In some embodiments, the preferential ranking may be determined based on one or more attributes of the purchaser entity with respect to historical transactions between the purchaser entity and each of the plurality of supplier entities. In certain embodiments, the one or more computer servers may then provide, based on the preferential rankings, a recommendation of preferential supplier entities for supplying the product or service to the purchaser entity. In some embodiments, providing the recommendation of preferential supplier entities may include providing, based on the preferential rankings, an ordered list of preferential supplier entities for supplying the product or service to the purchaser entity.

In one embodiment, the one or more computer servers may then cause one or more electronic devices associated with the purchaser entity to display the ordered list of preferential supplier entities. In one embodiment, the machine-learning model may include a gradient boosting model, an adaptive boosting (AdaBoost) model, an eXtreme gradient boosting (XGBoost) model, a light gradient boosted machine (LightGBM) model, or a categorical boosting (CatBoost) model. In some embodiments, prior to inputting the data for the set of transactions into the machine-learning model, the one or more computer servers may train the machine-learning model based on historical data for a set of transactions. In some embodiments, the historical data for the set of transactions may include one or more of previous transactions, an identification of the plurality of supplier entities, category master data, line-item master data, or master data associated with the purchaser entity.

Indeed, the present techniques of providing a procurement modeling system including one or more computer servers for predicting price reasonableness for procuring a product or service by a purchaser entity may provide technical improvements to previous or existing procurement-related cloud-computing based platforms. For example, in accordance with the presently disclosed techniques, the procurement modeling system may provide technical improvements to previous or existing procurement-related cloud-computing based platforms by increasing processing speeds of data processors and reducing database queries by indexing and organizing entities of data and manages data in a predetermined structured manner, such that a number of queries to the database in order to surface desired data is reduced as compared to performing a brute-force search of all of the entities of data stored in the database. For example, in accordance with the presently disclosed embodiments, the procurement modeling system may utilize one or machine-learning models to surface and generate desired data including, for example, preferential supplier entities for a purchaser entity and supplier entity pricing power.

### BRIEF DESCRIPTION OF THE DRAWINGS

FIG. 1 illustrates an embodiment of a procurement modeling system and network environment.

FIG. 2 illustrates an embodiment of a procurement modeling system for predicting preferential suppliers for a purchaser entity.

FIG. 3 illustrates a flow diagram of a method for predicting preferential suppliers for a purchaser entity.

FIG. 4 illustrates an embodiment of a procurement modeling system for predicting supplier entity pricing power for a purchaser entity.

FIG. 5 illustrates a flow diagram of a method for predicting supplier entity pricing power for a purchaser entity.

FIG. 6 illustrates an example procurement modeling computing system included as part of the procurement modeling system.

### DESCRIPTION OF EXAMPLE EMBODIMENTS

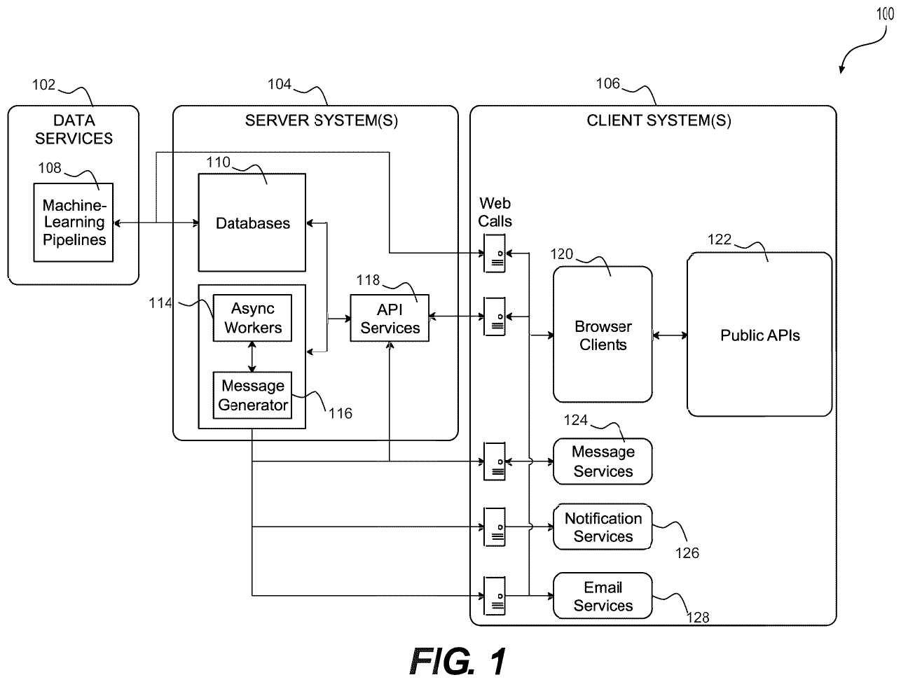

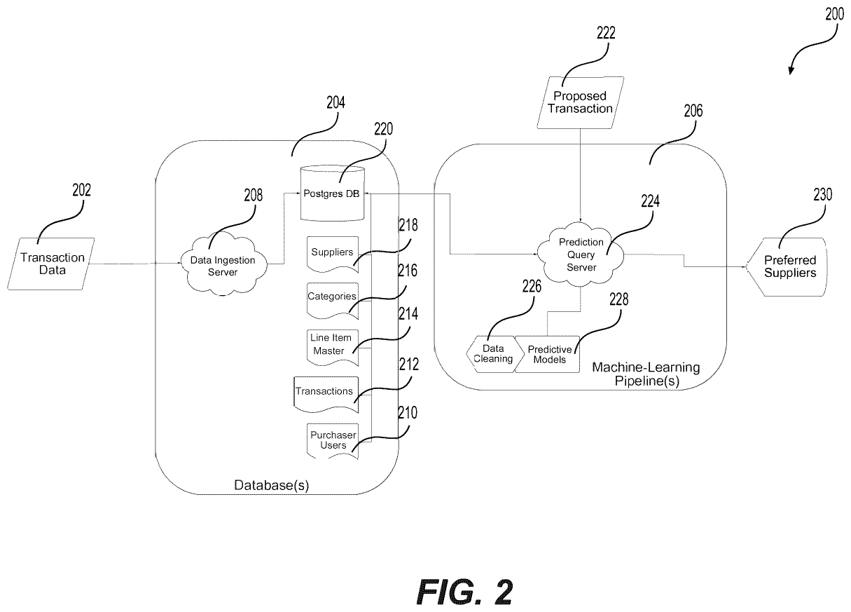

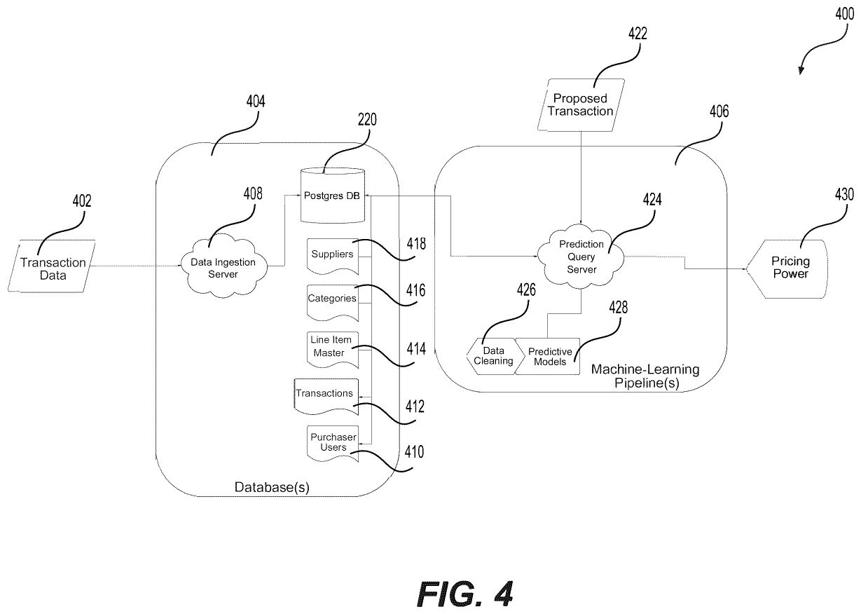

FIG. 1 illustrates a procurement modeling system and network environment 100 that may be utilized for predicting preferential supplier entities and supplier pricing power for a purchaser entity, in accordance with the presently disclosed embodiments. As depicted, in certain embodiments, the procurement modeling system and network environment 100 may include a data services system 102, a server system 104, and one or more client systems 106. In certain embodiments, the data services system 102 may include a predictive procurement orchestration (PPO) system, which may include one or more machine-learning model pipelines 108 for predicting price reasonableness for procuring a product or service by a purchaser entity, for example. Indeed, as will be described in greater detail below with respect to FIGS. 2 and 4, in accordance with the presently disclosed embodiments, the one or more machine-learning model pipelines 108 may be utilized to predict preferential suppliers for a purchaser entity and supplier entity pricing power for a purchaser entity.

In certain embodiments, the data services system 102 may be stored to one or more databases 112 and hosted and executed utilizing the server system 104. For example, in one embodiment, the server system 104 may include a Platform as a Service (PaaS), a Software as a Service (SaaS), a Compute as a Service (CaaS), an Infrastructure as a Service (IaaS), a Data as a Service (DaaS), a Database as a Service (DBaaS), or other similar cloud-based computing architecture (e.g., “X” as a Service (XaaS)) that may be suitable for generating and providing procurement recommendations to the one or more client systems 106. In certain embodiments, as further illustrated by FIG. 1, the server system 104 may include one or more asynchronous processing workers 114, a message generator 116, and application programming interface (API) services 118.

For example, in some embodiments, the one or more asynchronous processing workers 114, message generator 116, and API services 118 may operate in conjunction (e.g., in the background) for synchronously or asynchronously providing procurement recommendations to the one or more client systems 106 by way of browser client(s) 120, public APIs 122, messaging services 124, notification services 126, and email services 128. For example, in certain embodiments, the one or more client systems 106 may be associated, for example, with any number of respective purchaser entities, supplier entities, sourcing entities, or other entities that may be included as part of a procurement supply chain to which the procurement recommendations may be provided.

FIG. 2 illustrates an embodiment of a procurement modeling system 200 for predicting preferential suppliers for a purchaser entity, in accordance with the presently disclosed embodiments. For example, as illustrated by FIG. 2, the procurement modeling system 200 may include one or more database(s) 204 and one or more machine-learning model pipelines 206. In certain embodiments, during the training phase of the one or more machine-learning model pipelines 204, for example, a data ingestion server 208 of the one or more database(s) 204 may receive transaction data 202 (e.g., historical transaction data collected from any number of various purchaser entities or supplier entities over some period of time). For example, in some embodiments, the transaction data 202 may include historical line-item data including, for example, prices of products or services previously procured, quantities of the products or services previously procured, units of measure (UOM) with respect to the products or services previously procured, and so forth.

In certain embodiments, as further depicted by FIG. 2, the transaction data 202 may be stored to a relational database 220 (e.g., PostgreSQL or other similar object-relational database (ORD)) suitable for storing the transaction data 202 along with purchaser entity data attributes 210, transactions data attributes 212, line-item master data 214, categories master data 216, and supplier entity data attributes 218. For example, in certain embodiments, the purchaser entity data attributes 210 may include, for example, an identification of a purchaser entity, a specific company name for the purchaser entity, a geographical location of the purchaser entity, and so forth. Similarly, in certain embodiments, the transactions data attributes 212 may include, for example, line-item data derived from one or more historical data sets of requisitions, invoices, purchase orders, price quotes, sourcing events, and so forth.

For example, in some embodiments, the transactions data attributes 212 may include an identification of products or services included in the historical transaction data, a price of the product or services included in the historical transactions data, a quantity of the products or services in the historical transactions data, a UOM with respect to the products or services included in the historical transactions data, a currency utilized to purchase the products or services included in the historical transactions data, an identification of the purchaser entity associated with the products or services included in the historical transactions data, a line-item identification associated with the products or services included in the historical transactions data, a category identification associated with the products or services included in the historical transactions data, a supplier entity identification associated with the products or services included in the historical transactions data, a number of the requisitions, invoices, purchase orders, or sourcing events included in the historical transactions data, and a duration associated with the requisitions, invoices, purchase orders, or sourcing events included in the historical transactions data.

In certain embodiments, the line-item master data 214 may include, for example, a catalog or data log of all of the information that may be associated with products or services regularly, intermittently, or previously purchased by a particular purchaser entity, and may further include an identification of the purchaser entity, a description of the products or services identified by item-line, a category identification associated with the products or services, and so forth. In certain embodiments, the categories master data 216 may include an identification category, a description category, one or more naming categories, or a parent identification category that may be associated with supplier entities, purchaser entities, and/or one or more particular products or services. In certain embodiments, the supplier entity data attributes 218 may include, for example, an identification of supplier entities, a specific company name for supplier entities, geographical location of supplier entities, an identification of key supplier entities, an identification of valuable supplier entities, and so forth.

In certain embodiments, the transaction data 202 along with the purchaser entity data attributes 210, the transactions data attributes 212, the line-item master data 214, the categories master data 216, and the supplier entity data attributes 218 stored to the relational database 220 (e.g., PostgreSQL, ORD) may be utilized to train the one or more machine-learning model pipelines 204, and particularly one or more predictive procurement models 228. For example, in some embodiments, the one or more predictive procurement models 228 may include an ensemble-learning based regression model, such as a gradient boosting model, an adaptive boosting (AdaBoost) model, an eXtreme gradient boosting (XGBoost) model, a light gradient boosted machine (LightGBM) model, a categorical boosting (CatBoost) model, or a random forest model.

For example, in certain embodiments, the transaction data 202 and the purchaser entity data attributes 210, the transactions data attributes 212, the line-item master data 214, the categories master data 216, and the supplier entity data attributes 218 stored to the relational database 220 (e.g., PostgreSQL, ORD) may be accessed. In certain embodiments, before the transaction data 202 and the purchaser entity data attributes 210, the transactions data attributes 212, the line-item master data 214, the categories master data 216, and the supplier entity data attributes 218 are inputted to the one or more predictive procurement models 228 for training the one or more predictive procurement models 228 to predict preferential suppliers for a purchaser entity, these data may be passed to a data cleaner 226 that may be utilized to clean these data in order to avoid potentially overfitting the one or more predictive procurement models 228.

In certain embodiments, the purchaser entity data attributes 210, the transactions data attributes 212, the line-item master data 214, the categories master data 216, and the supplier entity data attributes 218 may be then inputted to the one or more predictive procurement models 228, which may be iteratively trained to generate predictions of preferential suppliers for a purchaser entity (e.g., an ordered list of preferential supplier entities for supplying a product or service). For example, as further illustrated by the procurement modeling system 200 of FIG. 2, once trained, the one or more predictive procurement models 228 may receive a newly proposed transaction 222 (e.g., corresponding to one or more price quotes, purchase orders, or requisitions received by a purchaser entity in real-time or near real-time) by way of a prediction query server 224.

For example, the proposed transaction 222 may include line-item data for one or more particular products or services being potentially procured by a purchaser entity. In certain embodiments, based on the line-item data included in the proposed transaction 222, the one or more predictive procurement models 228 may then generate a prediction of preferential suppliers for a purchaser entity 230 (e.g., an ordered list of preferential supplier entities for supplying a product or service) for procuring the one or more particular products or services corresponding to the line-item data included in the proposed transaction 222. For example, in some embodiments, the prediction of preferential suppliers for a purchaser entity 230 (e.g., an ordered list of preferential supplier entities for supplying a product or service) may include a recommendation of preferential supplier entities for supplying the product or service to the purchaser entity.

In one embodiment, the prediction of preferential suppliers for a purchaser entity 230 may be determined based on, for example, a monetary value of a sum of procurement transactions between the purchaser entity and each of the number of supplier entities with respect to the product or service (e.g., preference indicated by the amount of money spent). In another embodiment, the prediction of preferential suppliers for a purchaser entity 230 may be determined based on, for example, a determined negotiation behavior of each of the number of supplier entities (e.g., negotiation style or persona of each of the number of supplier entities, a degree of willingness to negotiate by each of the number of supplier entities, or a measure of engagement or responsiveness by each of the number of supplier entities)). Still, in other embodiments, the prediction of preferential suppliers for a purchaser entity 230 may be determined based on, for example, one or more attributes of the purchaser entity with respect to historical transactions between the purchaser entity and each of the plurality of supplier entities (e.g., an amount of knowledge or familiarity of the purchaser entity with respect to each of the plurality of supplier entities).

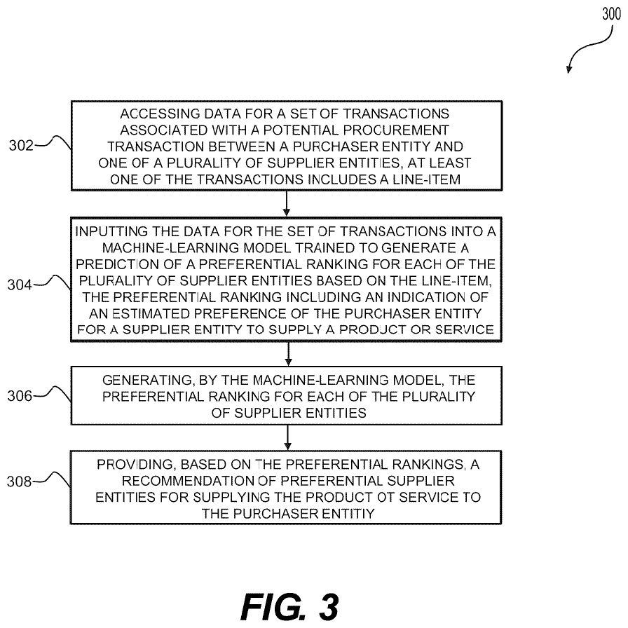

FIG. 3 illustrates a flow diagram of a method 300 for predicting preferential suppliers for a purchaser entity, in accordance with the presently disclosed embodiments. The method 300 may be performed utilizing one or more processing devices that may include hardware (e.g., a general purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), a deep learning processor (DLP), a tensor processing unit (TPU), neuromorphic processing unit (NPU), a wafer-scale engine (WSE), or any of various hardware artificial intelligence (AI) accelerators) that may be suitable for processing various transactions and making one or more decisions based thereon, software (e.g., instructions running/executing on one or more processing devices), firmware (e.g., microcode), or some combination thereof.

The method 300 may begin at block 302 with one or more processing devices accessing data for a set of transactions associated with a potential procurement transaction between a purchaser entity and at least one of a plurality of supplier entities. For example, at least one transaction of the set of transactions may include a line-item. The method 300 may continue at block 304 with one or more processing devices inputting the data for the set of transactions into a machine-learning model trained to generate a preferential ranking for each of the plurality of supplier entities based on the line-item. For example, the preferential ranking may include an estimated preference of the purchaser entity for a supplier entity of the plurality of supplier entities to supply a product or service to the purchaser entity, in which the product or service corresponds to the line-item.

The method 300 may then continue at block 306 with one or more processing devices generating, by the machine-learning model, the preferential ranking for each of the plurality of supplier entities. The method 300 may then continue at block 308 with one or more processing devices providing, based on the preferential rankings, a recommendation of preferential supplier entities for supplying the product or service to the purchaser entity. For example, providing the recommendation of preferential supplier entities may include providing, based on the preferential rankings, an ordered list of preferential supplier entities for supplying the product or service to the purchaser entity.

FIG. 4 illustrates an embodiment of a procurement modeling system 400 for predicting supplier entity pricing power for a purchaser entity, in accordance with the presently disclosed embodiments. For example, as illustrated by FIG. 4, the procurement modeling system 400 may include one or more database(s) 404 and one or more machine-learning model pipelines 406. In certain embodiments, during the training phase of the one or more machine-learning model pipelines 404, for example, a data ingestion server 408 of the one or more database(s) 404 may receive transaction data 402 (e.g., historical transaction data collected from any number of various purchaser entities or supplier entities over some period of time). For example, in some embodiments, the transaction data 402 may include historical line-item data including, for example, prices of products or services previously procured, quantities of the products or services previously procured, units of measure (UOM) with respect to the products or services previously procured, and so forth.

In certain embodiments, as further depicted by FIG. 4, the transaction data 402 may be stored to a relational database 420 (e.g., PostgreSQL or other similar ORD) suitable for storing the transaction data 402 along with purchaser entity data attributes 410, transactions data attributes 412, line-item master data 414, categories master data 416, and supplier entity data attributes 418. For example, in certain embodiments, the purchaser entity data attributes 410 may include, for example, an identification of a purchaser entity, a specific company name for the purchaser entity, a geographical location of the purchaser entity, and so forth. Similarly, in certain embodiments, the transactions data attributes 412 may include, for example, line-item data derived from one or more historical data sets of requisitions, invoices, purchase orders, price quotes, sourcing events, and so forth.

For example, in some embodiments, the transactions data attributes 412 may include an identification of products or services included in the historical transaction data, a price of the product or services included in the historical transactions data, a quantity of the products or services in the historical transactions data, a UOM with respect to the products or services included in the historical transactions data, a currency utilized to purchase the products or services included in the historical transactions data, an identification of the purchaser entity associated with the products or services included in the historical transactions data, a line-item identification associated with the products or services included in the historical transactions data, a category identification associated with the products or services included in the historical transactions data, a supplier entity identification associated with the products or services included in the historical transactions data, a number of the requisitions, invoices, purchase orders, or sourcing events included in the historical transactions data, and a duration associated with the requisitions, invoices, purchase orders, or sourcing events included in the historical transactions data.

In certain embodiments, the line-item master data 414 may include, for example, a catalog or data log of all of the information that may be associated with products or services regularly, intermittently, or previously purchased by a particular purchaser entity, and may further include an identification of the purchaser entity, a description of the products or services identified by item-line, a category identification associated with the products or services, and so forth. In certain embodiments, the categories master data 416 may include an identification category, a description category, one or more naming categories, or a parent identification category that may be associated with supplier entities, purchaser entities, and/or one or more particular products or services. In certain embodiments, the supplier entity data attributes 418 may include, for example, an identification of supplier entities, a specific company name for supplier entities, geographical location of supplier entities, an identification of key supplier entities, an identification of valuable supplier entities, and so forth.

In certain embodiments, the transaction data 402 along with the purchaser entity data attributes 410, the transactions data attributes 412, the line-item master data 414, the categories master data 416, and the supplier entity data attributes 418 stored to the relational database 420 (e.g., PostgreSQL, ORD) may be utilized to train the one or more machine-learning model pipelines 404, and particularly one or more predictive procurement models 428. For example, in some embodiments, the one or more predictive procurement models 428 may include an ensemble-learning based regression model, such as a gradient boosting model, an AdaBoost model, an XGBoost model, a LightGBM model, a CatBoost model, or a random forest model.

For example, in certain embodiments, the transaction data 402 and the purchaser entity data attributes 410, the transactions data attributes 412, the line-item master data 414, the categories master data 416, and the supplier entity data attributes 418 stored to the relational database 420 (e.g., PostgreSQL, ORD) may be accessed. In certain embodiments, before the transaction data 202 and the purchaser entity data attributes 410, the transactions data attributes 412, the line-item master data 414, the categories master data 416, and the supplier entity data attributes 418 are inputted to the one or more predictive procurement models 428 for training the one or more predictive procurement models 428 to predict preferential suppliers for a purchaser entity, these data may be passed to a data cleaner 426 that may be utilized to clean these data in order to avoid potentially overfitting the one or more predictive procurement models 428.

In certain embodiments, the purchaser entity data attributes 410, the transactions data attributes 412, the line-item master data 414, the categories master data 416, and the supplier entity data attributes 418 may be then inputted to the one or more predictive procurement models 428, which may be iteratively trained to generate predictions of a pricing power of each of a number of supplier entities (e.g., a likelihood of whether each supplier is to remain fixed to a price quotation for supplying a product or service to the purchaser entity). For example, as further illustrated by the procurement modeling system 400 of FIG. 4, once trained, the one or more predictive procurement models 428 may receive a newly proposed transaction 222 (e.g., corresponding to one or more price quotes, purchase orders, or requisitions received by a purchaser entity in real-time or near real-time) by way of a prediction query server 424. For example, the proposed transaction 422 may include line-item data for one or more particular products or services being potentially procured by a purchaser entity.

In certain embodiments, based on the line-item data included in the proposed transaction 422, the one or more predictive procurement models 428 may then generate a prediction of a pricing power of each of a number of supplier entities for a purchaser entity 430 (e.g., a likelihood of whether each supplier is to remain fixed to a price quotation for supplying a product or service) for procuring the one or more particular products or services corresponding to the line-item data included in the proposed transaction 422. For example, in some embodiments, prediction of the pricing power of a number of supplier entities for a purchaser entity 430 may include, for example, an estimate of whether one or more supplier entities are likely hold firm on a quoted pricing offer or subsequently increase its price following a contract award, for example.

In certain embodiments, the prediction of a pricing power of each of a number of supplier entities for a purchaser entity 430 may be determined, for example, based on one or more of a market competitiveness score with respect to products or services offered by each of the number of supplier entities, a geographical location competitiveness score with respect to products or services offered by each of the number of supplier entities, a relative amount of a pricing power of a supplier entity over time for products or services similar to the product or service to be supplied to the purchaser entity, or a frequency and a variance of transactions of a supplier entity relative to a frequency and a variance of one or more competitor supplier entities over time.

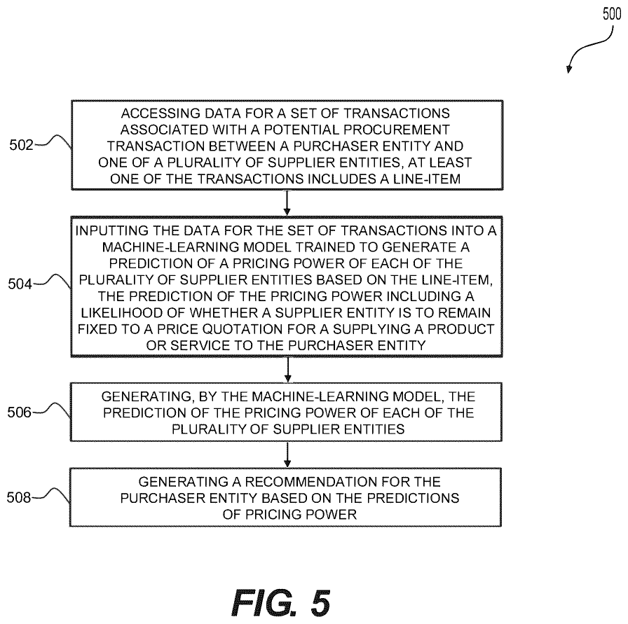

FIG. 5 illustrates a flow diagram of a method 500 for predicting supplier entity pricing power for a purchaser entity, in accordance with the presently disclosed embodiments. The method 500 may be performed utilizing one or more processing devices that may include hardware (e.g., a general purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), a deep learning processor (DLP), a tensor processing unit (TPU), neuromorphic processing unit (NPU), a wafer-scale engine (WSE), or any of various hardware artificial intelligence (AI) accelerators) that may be suitable for processing various transactions and making one or more decisions based thereon, software (e.g., instructions running/executing on one or more processing devices), firmware (e.g., microcode), or some combination thereof.

The method 500 may begin at block 502 with one or more processing devices accessing data for a set of transactions associated with a potential procurement transaction between a purchaser entity and at least one of a plurality of supplier entities. For example, at least one transaction of the set of transactions may include a line-item. The method 500 may continue at block 504 with one or more processing devices inputting the data for the set of transactions into a machine-learning model trained to generate a prediction of a pricing power of each of the plurality of supplier entities based on the line-item. For example, the prediction of the pricing power may include a likelihood of whether a supplier is to remain fixed to a price quotation for supplying a product or service to the purchaser entity, in which the product or service corresponds to the line-item. The method 500 may then continue at block 506 with one or more processing devices generating, by the machine-learning model, the prediction of the pricing power of each of the plurality of supplier entities. The method 500 may then continue at block 508 with one or more processing devices generating a recommendation for purchaser entity based on the prediction of the pricing power.

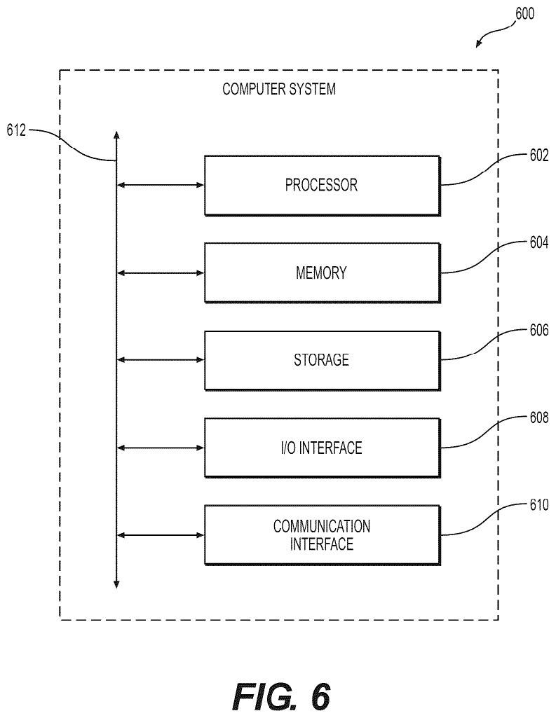

FIG. 6 illustrates an example procurement services computing system 600 (which may be included as part of the procurement services platform 102) that may be utilized for dynamically guiding users to request valid payments, in accordance with the presently disclosed embodiments. In certain embodiments, one or more financial services computing system 600 perform one or more steps of one or more methods described or illustrated herein. In certain embodiments, one or more financial services computing system 600 provide functionality described or illustrated herein. In certain embodiments, software running on one or more financial services computing system 600 performs one or more steps of one or more methods described or illustrated herein or provides functionality described or illustrated herein. Certain embodiments include one or more portions of one or more financial services computing system 600. Herein, reference to a computer system may encompass a computing device, and vice versa, where appropriate. Moreover, reference to a computer system may encompass one or more computer systems, where appropriate.

This disclosure contemplates any suitable number of financial services computing systems 600. This disclosure contemplates computer system 600 taking any suitable physical form. As example and not by way of limitation, computer system 600 may be an embedded computer system, a system-on-chip (SOC), a single-board computer system (SBC) (e.g., a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 600 may include one or more financial services computing system 600; be unitary or distributed; span multiple locations; span multiple machines; span multiple data centers; or reside in a cloud, which may include one or more cloud components in one or more networks.

Where appropriate, one or more financial services computing system 600 may perform without substantial spatial or temporal limitation one or more steps of one or more methods described or illustrated herein. As an example, and not by way of limitation, one or more financial services computing system 600 may perform in real time or in batch mode one or more steps of one or more methods described or illustrated herein. One or more financial services computing system 600 may perform at different times or at different locations one or more steps of one or more methods described or illustrated herein, where appropriate.

In certain embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement. In certain embodiments, processor 602 includes hardware for executing instructions, such as those making up a computer program. As an example, and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In certain embodiments, processor 602 may include one or more internal caches for data, instructions, or addresses. This disclosure contemplates processor 602 including any suitable number of any suitable internal caches, where appropriate. As an example, and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602.

Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In certain embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In certain embodiments, memory 604 includes main memory for storing instructions for processor 602 to execute or data for processor 602 to operate on. As an example, and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In certain embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere).

One or more memory buses (which may each include an address bus and a data bus) may couple processor 602 to memory 604. Bus 612 may include one or more memory buses, as described below. In certain embodiments, one or more memory management units (MMUs) reside between processor 602 and memory 604 and facilitate accesses to memory 604 requested by processor 602. In certain embodiments, memory 604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memory devices 604, where appropriate. Although this disclosure describes and illustrates particular memory, this disclosure contemplates any suitable memory.

In certain embodiments, storage 606 includes mass storage for data or instructions. As an example, and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In certain embodiments, storage 606 is non-volatile, solid-state memory. In certain embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In certain embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 606 for them. Where appropriate, I/O interface 608 may include one or more device or software drivers enabling processor 602 to drive one or more of these I/O devices. I/O interface 608 may include one or more I/O interfaces 606, where appropriate. Although this disclosure describes and illustrates a particular I/O interface, this disclosure contemplates any suitable I/O interface.

In certain embodiments, communication interface 610 includes hardware, software, or both providing one or more interfaces for communication (such as, for example, packet-based communication) between computer system 600 and one or more other computer systems 600 or one or more networks. As an example, and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it.

As an example, and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In certain embodiments, bus 612 includes hardware, software, or both coupling components of computer system 600 to each other. As an example, and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

Herein, “automatically” and its derivatives means “without human intervention,” unless expressly indicated otherwise or indicated otherwise by context.

The embodiments disclosed herein are only examples, and the scope of this disclosure is not limited to them. Embodiments according to this disclosure are in particular disclosed in the attached claims directed to a method, a storage medium, a system and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates certain embodiments as providing particular advantages, certain embodiments may provide none, some, or all of these advantages.

1. A method for generating a machine-learning output of a recommended supplier for supplying a particular line-item to a purchaser, comprising, by one or more computing devices:
receiving, by a data ingestion server, historical transaction data for a set of transactions associated with at least one supplier from a plurality of suppliers;
storing the historical transaction data in a database, wherein the database further stores data associated with:
a set of attributes of a plurality of line-items associated with the set of transactions, wherein the plurality of line-items comprise one or more line-items other than the particular line-item, wherein the set of attributes comprises a quantity of a product and a unit of measure with respect to the product, and
a set of attributes of the at least one supplier from the plurality of suppliers;
obtaining a first set of training data at least by retrieving a first set of the historical transaction data, the data associated with the set of attributes of the plurality of line-items, and the data associated with the set of attributes of the at least one supplier from the database;
structuring the first set of training data to avoid overfitting of a machine-learning model by:
detecting, by an outlier detector, one or more outlier data items in the first set of the historical transaction data; and
removing, by a data cleaner, the one or more outlier data items from the first set of the historical transaction data;
training, based on the first set of training data, the machine-learning model to generate outputs corresponding to the at least one supplier from the plurality of suppliers;
receiving, through a prediction query server, a user input specifying a potential procurement transaction for the particular line-item between the purchaser and one of the at least one supplier from the plurality of suppliers;
inputting data associated with the user input into the machine-learning model to generate:
a purchaser-specific preferential ranking for each of the at least one supplier from the plurality of suppliers, wherein the purchaser-specific preferential ranking is based on an estimated purchaser-specific preference of the purchaser for each of the at least one supplier from the plurality of suppliers to supply the particular line-item to the purchaser; and
a selection of one of the at least one supplier from the plurality of suppliers to supply the particular line-item to the purchaser, wherein the selection is based on the purchaser-specific preferential ranking;
obtaining a second set of training data at least by retrieving a second set of historical transaction data, wherein the second set of historical transaction data comprises one or more price quotes; and
iteratively training, based on the second set of training data, the machine-learning model to generate updated outputs corresponding to the at least one supplier from the plurality of suppliers.

2. The method of claim 1, wherein each of the set of transactions comprises a line-item and an identification of a corresponding purchaser.

3. The method of claim 2, wherein the line-item comprises a price of the particular line-item.

4. The method of claim 1, further comprising providing, based on the purchaser-specific preferential ranking, an ordered list of preferential suppliers for supplying the particular line item to the purchaser.

5. The method of claim 4, further comprising causing one or more electronic devices associated with the purchaser to display the ordered list of preferential suppliers.

6. The method of claim 1, wherein the purchaser-specific preferential ranking is determined based on a market competitiveness score with respect to products or services offered by the at least one supplier from the plurality of suppliers.

7. The method of claim 1, wherein the purchaser-specific preferential ranking is determined based on a monetary value of a sum of procurement transactions between the purchaser and each of the at least one supplier from the plurality of suppliers with respect to the particular line-item.

8. The method of claim 1, wherein the purchaser-specific preferential ranking is determined based on a determined negotiation behavior of each of the at least one supplier from the plurality of suppliers.

9. The method of claim 1, wherein the purchaser-specific preferential ranking is determined based on one or more attributes of the purchaser with respect to historical transactions between the purchaser and each of the at least one supplier from the plurality of suppliers.

10. The method of claim 1, wherein the machine-learning model comprises a gradient boosting model, an adaptive boosting (AdaBoost) model, an eXtreme gradient boosting (XGBoost) model, a light gradient boosted machine (LightGBM) model, or a categorical boosting (CatBoost) model.

11. (canceled)

12. The method of claim 1, wherein the historical transaction data for the set of transactions comprises one or more of previous transactions, an identification of the at least one supplier from the plurality of suppliers, category master data, line-item master data, or master data associated with the purchaser.

13. A method for generating a predicted pricing power of a supplier entity for supplying a product or server to a purchaser entity, comprising, by one or more computing devices:
accessing data for a set of transactions associated with a potential procurement transaction between a purchaser entity and at least one of a plurality of supplier entities, wherein at least one of the transactions comprises a line-item;
inputting the data for the set of transactions into a machine-learning model trained to generate a prediction of a pricing power of each of the plurality of supplier entities based on the line-item, wherein the prediction of the pricing power comprises a likelihood of whether a supplier is to remain fixed to a price quotation for supplying a product or service to the purchaser entity, the product or service corresponding to the line-item;
generating, by the machine-learning model, the prediction of the pricing power of each of the plurality of supplier entities; and
generating a recommendation for purchaser entity based on the prediction of the pricing power.

14. The method of claim 13, wherein the prediction of the pricing power is determined based on a market competitiveness score with respect to products or services offered by the plurality of supplier entities.

15. The method of claim 13, wherein the prediction of the pricing power is determined based on a geographical location competitiveness score with respect to products or services offered by the plurality of supplier entities.

16. The method of claim 13, wherein the prediction of the pricing power is determined based on a relative amount of a pricing power of a supplier entity over time for products or services similar to the product or service to be supplied to the purchaser entity.

17. The method of claim 1, wherein the prediction of the pricing power is determined based on a frequency and a variance of transactions of a supplier entity relative to a frequency and a variance of one or more competitor supplier entities over time.

18. The method of claim 13, further comprising:
prior to inputting the data for the set of transactions into the machine-learning model, training the machine-learning model based on historical data for a set of transactions.

19. The method of claim 18, wherein the historical data for the set of transactions comprises one or more of previous transactions, an identification of the plurality of supplier entities, category master data, line-item master data, or master data associated with the purchaser entity.

20. A non-transitory computer-readable medium comprising instructions that, when executed by one or more computer servers associated with a procurement services platform, cause the one or more computer servers to:
receive, by a data ingestion server, historical transaction data for a set of transactions associated with at least one supplier from a plurality of suppliers;
store the historical transaction data in a database, wherein the database further stores data associated with:
a set of attributes of a plurality of line-items associated with the set of transactions, wherein the plurality of line-items comprise one or more line-items other than the particular line-item, wherein the set of attributes comprises a quantity of a product and a unit of measure with respect to the product, and
a set of attributes of the at least one supplier from the plurality of suppliers;
obtain a first set of training data at least by retrieving a first set of the historical transaction data, the data associated with the set of attributes of the plurality of line-items, and the data associated with the set of attributes of the at least one supplier from the database;
structure the first set of training data to avoid overfitting of a machine-learning model by:
detecting, by an outlier detector, one or more outlier data items in the first set of the historical transaction data; and
removing, by a data cleaner, the one or more outlier data items from the first set of the historical transaction data;
train, based on the first set of training data, the machine-learning model to generate outputs corresponding to the at least one supplier from the plurality of suppliers;
receive, through a prediction query server, a user input specifying a potential procurement transaction for the particular line-item between the purchaser and one of the at least one supplier from the plurality of suppliers;
input data associated with the user input into the machine-learning model to generate:
a purchaser-specific preferential ranking for each of the at least one supplier from the plurality of suppliers, wherein the purchaser-specific preferential ranking is based on an estimated purchaser-specific preference of the purchaser for each of the at least one supplier from the plurality of suppliers to supply the particular line-item to the purchaser; and
a selection of one of the at least one supplier from the plurality of suppliers to supply the particular line-item to the purchaser, wherein the selection is based on the purchaser-specific preferential ranking;
obtain a second set of training data at least by retrieving a second set of historical transaction data, wherein the second set of historical transaction data comprises one or more price quotes; and
iteratively train, based on the second set of training data, the machine-learning model to generate updated outputs corresponding to the at least one supplier from the plurality of suppliers.

21. A system including one or more computing devices for generating a machine-learning output of a recommended supplier for supplying a particular line-item to a purchaser, the one or more computing devices comprising:
one or more non-transitory computer-readable storage media including instructions; and
one or more processors coupled to the one or more storage media, the one or more processors configured to execute the instructions to:
receive, by a data ingestion server, historical transaction data for a set of transactions associated with at least one supplier from a plurality of suppliers;
store the historical transaction data in a database, wherein the database further stores data associated with:
a set of attributes of a plurality of line-items associated with the set of transactions, wherein the plurality of line-items comprise one or more line-items other than the particular line-item, wherein the set of attributes comprises a quantity of a product and a unit of measure with respect to the product, and
a set of attributes of the at least one supplier from the plurality of suppliers;
obtain a first set of training data at least by retrieving a first set of the historical transaction data, the data associated with the set of attributes of the plurality of line-items, and the data associated with the set of attributes of the at least one supplier from the database;
structure the first set of training data to avoid overfitting of a machine-learning model by:
detecting, by an outlier detector, one or more outlier data items in the first set of the historical transaction data; and
removing, by a data cleaner, the one or more outlier data items from the first set of the historical transaction data;
train, based on the first set of training data, the machine-learning model to generate outputs corresponding to the at least one supplier from the plurality of suppliers;
receive, through a prediction query server, a user input specifying a potential procurement transaction for the particular line-item between the purchaser and one of the at least one supplier from the plurality of suppliers;
input data associated with the user input into the machine-learning model to generate:
a purchaser-specific preferential ranking for each of the at least one supplier from the plurality of suppliers, wherein the purchaser-specific preferential ranking is based on an estimated purchaser-specific preference of the purchaser for each of the at least one supplier from the plurality of suppliers to supply the particular line-item to the purchaser; and
a selection of one of the at least one supplier from the plurality of suppliers to supply the particular line-item to the purchaser, wherein the selection is based on the purchaser-specific preferential ranking;
obtain a second set of training data at least by retrieving a second set of historical transaction data, wherein the second set of historical transaction data comprises one or more price quotes; and
iteratively train, based on the second set of training data, the machine-learning model to generate updated outputs corresponding to the at least one supplier from the plurality of suppliers.

22. The method of claim 1, wherein the second set of training data comprises one or more of purchaser data attributes, transactions data attributes, line-item master data, categories master data, and supplier data attributes.
